(19) United States
(12) Patent Application Publication
(10) Pub. No.: US 2014/0133473 A1
(43) Pub. Date: May 15, 2014

(54) APPARATUS AND METHOD FOR MANAGING SLOT

(71) Applicant: ELECTRONICS AND TELECOMMUNICATIONS RESEARCH INSTITUTE, Daejeon (KR)

(72) Inventors: Chang Sub Shin, Daejeon (KR); Wun-Cheol Jeong, Daejeon (KR); Hoyong Kang, Daejeon (KR); Byeong Cheol Choi, Daejeon (KR)

(73) Assignee: ELECTRONICS AND TELECOMMUNICATIONS RESEARCH INSTITUTE, Daejeon (KR)

(21) Appl. No.: 14/040,857

(22) Filed: Sep. 30, 2013

(30) Foreign Application Priority Data
Nov. 9, 2012 (KR) 10-2012-0126775

(51) Int. Cl. H04W 72/04

(52) U.S. Cl. CPC H04W 72/0446
USPC 370/336

(57) ABSTRACT

An end device transmits a request command for requesting a slot management to a coordinator, and receives a reply command including a result of the slot management request from the coordinator. Each of the request command and the reply command includes an allocation order for indicating a slot allocation interval request.

### CROSS-REFERENCE TO RELATED APPLICATION

This application claims priority to and the benefit of Korean Patent Application No. 10-2012-0126775 filed in the Korean Intellectual Property Office on Nov. 9, 2012, the entire contents of which are incorporated herein by reference.

### BACKGROUND OF THE INVENTION

(a) Field of the Invention

The present invention generally relates to a slot management method and apparatus.

(b) Description of the Related Art

Requirements for wireless sensor network systems are increased in industries requiring the reliability. Particularly, the high reliability and the minimization of a data transmission delay time between terminal nodes are required at transmission of data.

A wireless personal area network (WPAN) may be used as the wireless sensor network system. The WPAN is defined in, for example, the IEEE 802.15 standard. Particularly, the IEEE 802.15.4 defines medium access control (MAC) technologies of the WPAN.

The MAC technologies of the IEEE 802.15.4 are classified into a beacon mode and a non-beacon mode. In the beacon mode, a network is formed by a tree structure starting from a coordinator of a personal area network (PAN). Each node allocates an independent active duration according to a scheduling scheme supported by a user, and supports a communication during the active duration. However, because a mesh network cannot be supported in the beacon mode, the redundancy of paths, which is a problem of the beacon mode, exist. Therefore, it is difficult to support services requiring the low delay between the terminal nodes. Further, problems of a packet collision and a transmission delay exist in the non-beacon mode because all nodes use contention-based data transmission.

Therefore, in order to minimize the data transmission delay time between the terminal nodes, a method for efficiently managing durations in which each node transmits data, i.e., time slots is required.

### SUMMARY OF THE INVENTION

An aspect of the present invention provides a slot management method and apparatus for reducing control information for a plurality of end devices and for efficiently allocating a slot.

According to another aspect of the present invention, a method of managing a slot is provided by a coordinator to which a plurality of end devices are connected in a wireless network. The method includes receiving a request command for requesting a slot management from a predetermined end device, and transmitting a reply command including a result of the slot management request to the end device in accordance with the slot management request. Each of the request command and the reply command includes an allocation order for indicating a slot allocation interval.

The coordinator may include a first layer and a second layer that is an upper layer of the first layer. In this case, the method may further include transferring a first primitive for reporting a receipt of the request command from the first layer to the second layer the first, and transferring a second primitive from the second layer to the first layer, as a response to the slot management request.

A scheme for exchanging the request command and the reply command may be applied to a mode in which a multi-superframe duration is longer than a beacon interval.

The slot allocation interval may be defined as BI×2^{(MO-BO)}/2^{AO}, wherein the BI indicates a beacon interval, the MO indicates a value for representing a multi-superframe duration, the BO indicates a value for representing the beacon interval, and the AO indicates the allocation order.

The beacon interval may be a product of a predetermined duration and 2^{BO}, and the multi-superframe duration may be a product of the predetermined duration and 2^{MO}.

The result of the slot management request may include an index of an allocated beacon interval, an identifier of an allocated superframe within the allocated beacon interval, and an identifier of an allocated slot within the allocated superframe.

The result of the slot management request may further include a channel index indicating channel information.

According to yet another aspect of the present invention, a method of managing a slot is provided by an end device connected to a coordinator in a wireless network. The method includes transmitting a request command for requesting a slot management to the coordinator, and receiving a reply command including a result of the slot management request from the coordinator. Each of the request command and the reply command includes an allocation order for indicating a slot allocation interval.

The end device may include a first layer and a second layer that is an upper layer of the first layer. In this case, the method may further include transferring a first primitive for requesting the slot management from the first layer to the second layer, and transferring a second primitive for reporting the result of the slot management request from the second layer to the first layer.

A scheme for exchanging the request command and the reply command may be applied to a mode in which a multi-superframe duration is longer than a beacon interval.

The slot allocation interval may be defined as BI×2^{(MO-BO)}/2^{AO}, wherein the BI indicates a beacon interval, the MO indicates a value for representing a multi-superframe duration, the BO indicates a value for representing the beacon interval, and the AO indicates the allocation order.

The beacon interval may be a product of a predetermined duration and 2^{B0}, and the multi-superframe duration may be a product of the predetermined duration and 2^{MO}.

The result of the slot management request may include an index of an allocated beacon interval, an identifier of an allocated superframe within the allocated beacon interval, and an identifier of an allocated slot within the allocated superframe.

The result of the slot management request may further include a channel index indicating channel information.

According to still another aspect of the present invention, a slot management apparatus of a coordinator to which a plurality of end device are connected in a wireless network is provided. The slot management apparatus includes a transceiver configured to receive a request command for requesting a slot management from a predetermined end device and transmit a reply command to the end device, and a processor configured to perform the slot management in accordance with the slot management request and generate the reply command including a result of the slot management request. Each of the request command and the reply command includes an allocation order for indicating a slot allocation interval.

A scheme for exchanging the request command and the reply command may be applied to a mode in which a multi-superframe duration is longer than a beacon interval.

The result of the slot management request may include an index of an allocated beacon interval, an identifier of an allocated superframe within the allocated beacon interval, and an identifier of an allocated slot within the allocated superframe.

According to further aspect of the present invention, a slot management apparatus of an end device connected to a coordinator in a wireless network is provided. The slot management apparatus includes a processor configured to generate a request command for requesting a slot management, and a transceiver configured to transmit the request command to the coordinator and receive a reply command including a result of the slot management request from the coordinator. Each of the request command and the reply command includes an allocation order for indicating a slot allocation interval.

A scheme for exchanging the request command and the reply command may be applied to a mode in which a multi-superframe duration is longer than a beacon interval.

The result of the slot management request may include an index of an allocated beacon interval, an identifier of an allocated superframe within the allocated beacon interval, and an identifier of an allocated slot within the allocated superframe.

### BRIEF DESCRIPTION OF THE DRAWINGS

FIG. 1 and FIG. 2 are drawings showing a structure of a multi-superframe in a wireless sensor network system according to an embodiment of the present invention.

FIG. 3 and FIG. 5 are schematic drawings showing a slot management method according to an embodiment of the present invention.

FIG. 4 and FIG. 6 are signal flowcharts showing a slot management method according to an embodiment of the present invention.

FIG. 7 is a block diagram of a slot management apparatus according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

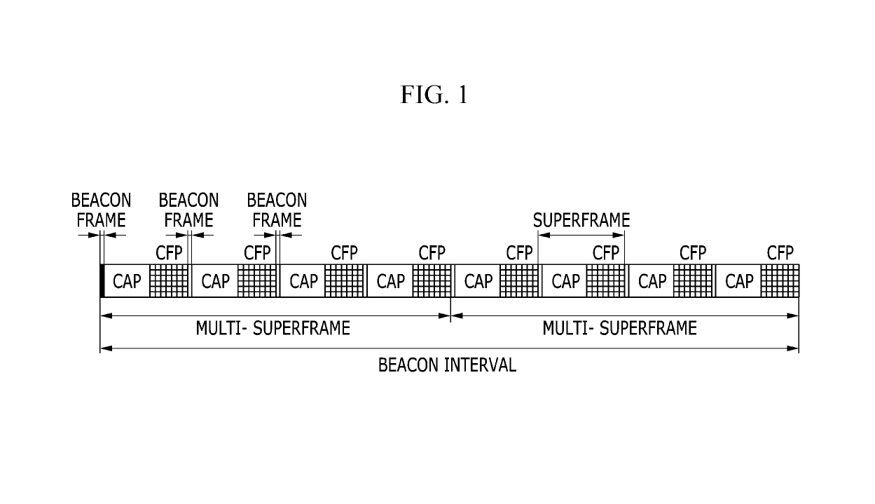

FIG. 1 is a drawing showing a structure of a multi-superframe in a wireless sensor network system according to an embodiment of the present invention.

Referring to FIG. 1, the multi-superframe corresponds to a cycle of repeated superframes, and includes a plurality of superframes. The plurality of superframes, for example two superframes configures a beacon interval (BI). Each superframe includes a beacon frame, a contention access period (CAP), and a contention free period (CFP). Each node transmits or receives a beacon in the beacon frame. For example, a certain node may transmit the beacon in the first beacon frame, and may receive the beacon in the remaining beacon frames. A plurality of slots are allocated to the CFP. The CFP is divided into a plurality of time slots in a time axis direction, and is divided into a plurality of channels in a frequency axis direction. An area defined by one time slot and one channel corresponds to a slot. This slot may be referred to as a deterministic and synchronous multi-channel extension guaranteed time slot (DSME-GTS). The DSME-GTS may be defined by a slot number and a channel number.

Since the number of DSME-GTSs that a signal node can use is restricted, the multi-superframe is used by grouping the plurality of superframe as shown in FIG. 1. The size and structure of the multi-superframe may depend on values of beacon order (BO), superframe order (SO) and multi-superframe order (MO). The BO denotes a value representing a beacon interval, the SO denotes a value representing a superframe duration, and the MO denotes a value representing a multi-superframe duration.

For example, the number (N_{S}) of superframes in the multi-superframe, the number (N_{M}) of superframes in the beacon interval, the superframe duration (SD), the multi-superframe duration (MD), and the beacon interval (BI) may be defined as expressed in Equation 1.

N_{S}=2^{(MO-SO)}

N_{M}=2^{(BO-MO)} Equation 1

SD=aBaseSuperframeDuration×2^{SO} symbol

MD=aBaseSuperframeDuration×2^{MO} symbol

BI=aBaseSuperframeDuration×2^{B0} symbol

Herein, aBaseSuperframeDuration denotes a predetermined length for representing a basic length of the superframe.

An example shown in FIG. 1 represents a multi-superframe structure where the BO, SO, and MO are six, three, and five.

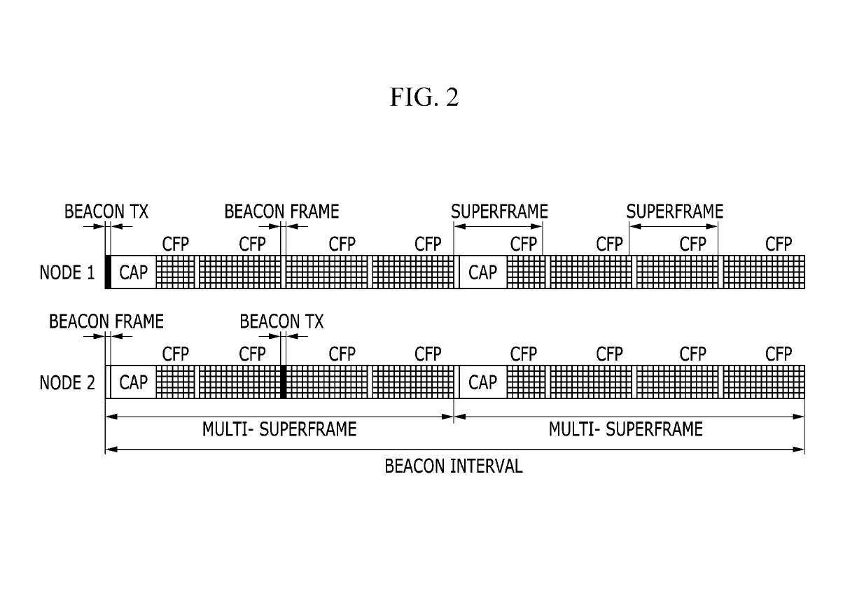

FIG. 2 is a drawing showing a structure of a multi-superframe in a wireless sensor network system according to another embodiment of the present invention.

Referring to FIG. 2, the number of CAPs for each multi-superframe is set to 1 such that the number of DSME-GTSs is increased in a multi-superframe and transmission delay is reduced. The CAP is located after the first beacon frame of the multi-superframe. In the case of the second beacon frame or beacon frames subsequent to the second beacon frames in the multi-superframe, the CAP does not follow immediately after the beacon frames. Thus, the beacon frame may specify a time when a next CAP starts.

In FIG. 2, a node 1 transmits a beacon at the first beacon frame, and a node 2 transmits a beacon at the third beacon frame.

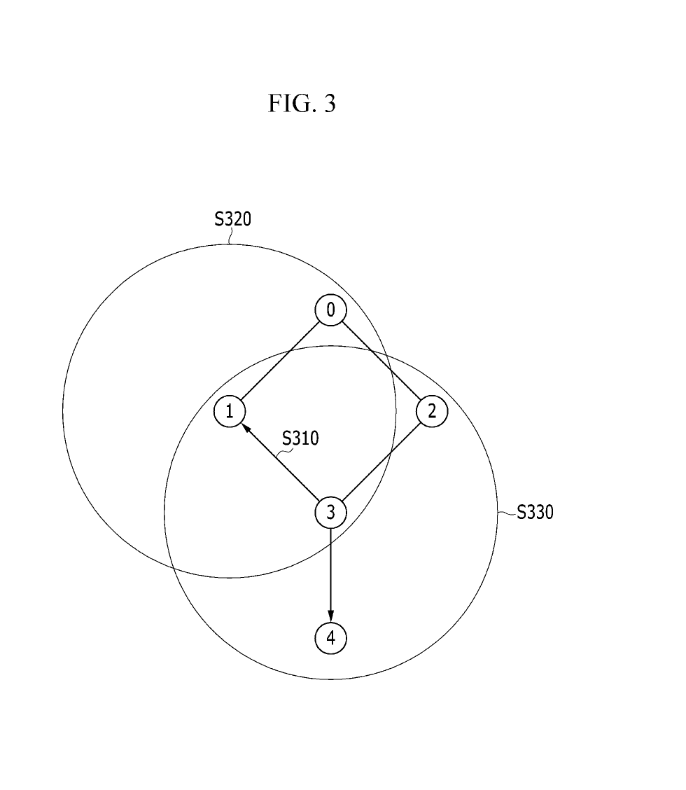

Hereinafter, a slow managing method according to various embodiments of the present invention is described with reference to FIG. 3 to FIG. 6.

FIG. 3 is a schematic drawing showing a slot management method according to an embodiment of the present invention.

In FIG. 3, it is assumed that a node 3 transmits a request of a slow allocation to a node 1, and slots for data transmission have been already allocated between a node 4 and the node 3.

Referring to FIG. 3, the node 3 transmits a DSME-GTS request command for requesting the slot allocation to a node (S310). The DSME-GTS request command includes the number of slots that it is requesting and DSME slot allocation bitmap (SAB) sub-block information. DSME SAB sub-block information may have a bitmap format, and indicates readily allocated or unavailable slots (for example, bits with ‘1’ in the bitmap) and available slots (for example, bits with ‘0’ in the bitmap).

The node 1 allocates slots for the node 3, and broadcasts a DSME-GTS reply command including the allocated slot information and a destination address to neighboring nodes (S320). The allocated slots information includes DSME SAB sub-block information, and the destination address is an address of the node 3. Then, the nodes 0 and 3 that are the neighboring nodes of node 1 receive DSME-GTS reply command.

The node 3 corresponding to the destination of the DSME-GTS reply command broadcasts a DSME-GTS notify command including allocated slot information and a destination address to the neighboring nodes, thereby notifying the neighboring nodes of the result of allocation (S330). The allocated slot information includes DSME SAB sub-block information, and the destination address is an address of the node 1. Then, the nodes 1, 2 and 4 that are the neighboring nodes of the node 3 receive the DSME-GTS notify command.

As such, according to an embodiment of the present invention, the node 1, i.e., a destination node allocates slots such that the slots can be allocated by exchange of three commands. As a result, a transmission delay time can be minimized. Further, the nodes 0, 2 and 4 corresponding to the neighboring nodes of the nodes 1 and 3 can update current slot information by the broadcasted command frame, so the reliability of the slot allocation can be improved.

While it has been described in FIG. 3 that the slots are allocated by the DSME-GTS request command, the DSME-GTS reply command, and the DSME-GTS notify command, these commands can be used for the other managements of the slots as well as the allocation of the slots. The management type may be allocation of new slots, or deallocation, duplicated allocation notification, reduce, or restart of existing slots.

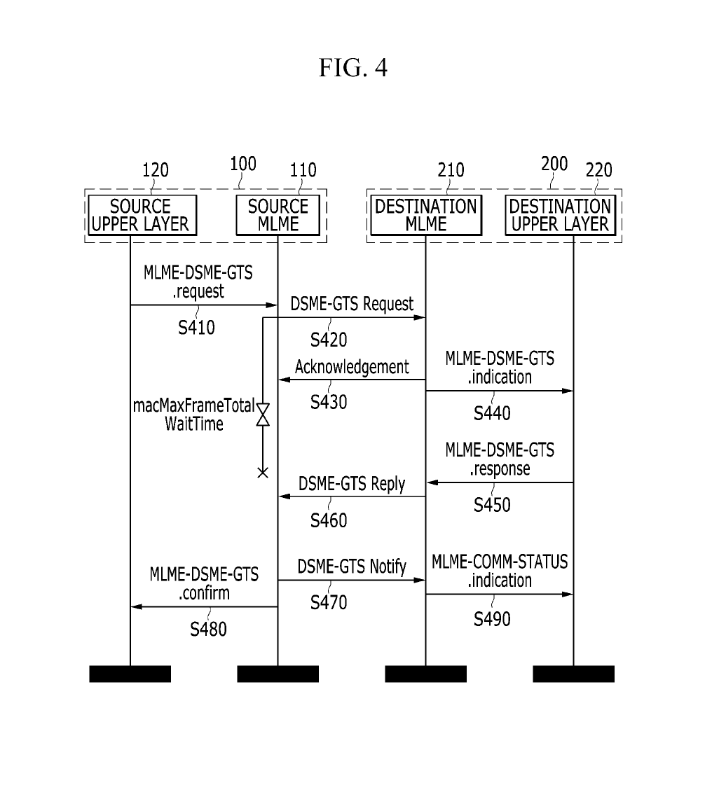

FIG. 4 is a signal flowchart of a slot management method according to an embodiment of the present invention.

Referring to FIG. 4, a source node 100 includes a MAC sublayer management entity (MLME) (hereinafter referred to as “a source MLME”) 110 and an upper layer (hereinafter referred to as “source upper layer”) 120 of the MLME 110. A destination node 200 also includes an MLME (hereinafter referred to as “a destination MLME”) 210 and an upper layer (hereinafter referred to as “a destination upper layer”) 220. The source node 100 may request management of slots to the destination node 200.

The source upper layer 120 transfers an MLME-DSME-GTS.request primitive that is a primitive for requesting a slot management to the source MLME 110 (S410). Then, the source MLME 110 transmits the DSME-GTS request command for requesting the slot management to the destination MLME 210 (S420). The destination MLME 210 may transmit an acknowledgement message on the DSME-GTS request command to the source MLME 110 (S430).

Next, the destination MLME 210 transfers an MLME-DSME-GTS.indication primitive for reporting the receipt of the DSME-GTS request command to the upper layer 220 of the destination node 200 (S440). The destination upper layer 220 performs the requested management for the source node 110 in accordance with the MLME-DSME-GTS.indication primitive, and transfers an MLME-DSME-GTS.response primitive as a response to the destination MLME 210 (S450). The requested management is allocation of new slots, or deallocation, duplicated allocation notification, reduce, or restart of existing slots. Then, the destination MLME 210 broadcasts a DSME-GTS reply command to neighboring nodes including the source node 100, to report the result of management request (S460).

The source MLME 110 broadcasts a DSME-GTS notify command to neighboring nodes including the destination node 200, to report the result of management request (S470). Further, the source MLME 110 transfers an MLME-DSME-GTS.confirm primitive to the upper layer 120 to report the result of management request (S480). The destination MLME 210 reports the receipt of the DSME-GTS notify command to the upper layer 220 using an MLME-COMM-STATUS.indication primitive (S490).

Next, parameters of the commands and primitives described in FIG. 4 is described with reference to Tables 1 to 4.

Referring to Table 1, a frame of the DSME-GTS request command includes a MAC header (MHR) field, a command frame identifier (ID) field, a DSME-GTS management field, a number of slots field, a preferred superframe ID field, a preferred slot ID field, and a DSME SAB specification field.

TABLE 1

| Octets | Name |
|---|---|
| Variable | MHR |
| 1 | Command Frame ID |
| 1 | DSME-GTS Management |
| 0/1 | Number of Slots |
| 0/2 | Preferred Superframe ID |
| 0/1 | Preferred Slot ID |
| Variable | DSME SAB Specification |

The MHR field includes a source address and a destination address. The DSME-GTS management field includes a management type field, and the management type field has information of Table 2 in accordance with its value. Referring to Table 3, the DSME-GTS management field may further include a direction field, a prioritized channel access field, and a reserved field. The direction field indicates whether the DSME-GTS is allocated for transmission or is allocated for reception. The prioritized channel access field indicates whether the DSME-GTS should be reserved with the high priority, or be reserved with the low priority.

TABLE 2

| Management Type Value b₂b₁b₀ | Description |
|---|---|
| 000 | Deallocation |
| 001 | Allocation |
| 010 | Duplicated Allocation Notification |
| 011 | Reduce |
| 100 | Restart |
| 101 | DSME-GTS Expiration |
| 110-111 | Reserved |

TABLE 3

| Bits | Name |
|---|---|
| 0-2 | Management Type |
| 3 | Direction |
| 4 | Prioritized Channel Access |
| 5-7 | Reserved |

In Table 1, the number of slots, the preferred superframe ID, and the preferred slot ID exist when the management type indicates “allocation”. The number of slots indicates the number of DSME-GTSs that a corresponding command requests, the preferred superframe ID indicates an index of a preferred superframe in which the DSME-GTSs need be allocated, and the preferred slot ID indicates an index of a preferred slot from which the DSME-GTSs need be allocated. The DSME SAB specification includes DSME SAB sub-block information to be managed, and may have a bitmap format. When the management type is “allocation”, the DSME SAB sub-block information indicates readily allocated or unavailable slots (for example, bits with ‘1’ in the bitmap) and available slots (for example, bits with ‘0’ in the bitmap). When the management type is not “allocation”, the DSME SAB sub-block information slots (for example, bits with “1” in the bitmap) to be managed, that is, slots that are being requested deallocation, duplicated allocation notification, reduce, or restart. The DSME SAB specification may further include a length of DSME SAB sub-block and an index indicating the beginning of the DSME SAB sub-block.

Referring to Table 4, a frame of the DSME-GTS reply command includes an MHR field, a command frame ID field, a DSME-GTS management field, a destination address field, a channel offset field, and a DSME SAB specification field. Since the DSME-GTS reply command is broadcasted, a destination address of the MHR is set to a broadcast address. The destination address field includes an address of a destination of the DSME-GTS reply command, i.e., an address of the source node 100. The DSME-GTS management field includes a status as well as a management type, and the status indicates the result of the DSME-GTS request. A DSME SAB sub-block of the DSME SAB specification indicates slots that are selected for allocation, deallocation, duplicated allocation notification, reduce, or restart.

TABLE 4

| Octets | Name |
|---|---|
| Variable | MHR |
| 1 | Command Frame ID |
| 1 | DSME-GTS Management |
| 2 | Destination Address |
| 0/1 | Channel Offset |
| Variable | DSME SAB Specification |

A frame of the DSME-GTS notify command also includes an MHR field, a command frame ID field, a DSME-GTS management field, a destination address field, a channel offset field, and a DSME SAB specification field as Table 4. Since the DSME-GTS notify command is broadcasted, a destination address of the MHR is set to a broadcast address. The destination address filed includes an address of a destination of the DSME-GTS notify command, i.e., an address of the destination node 200. A DSME SAB sub-block of the DSME SAB specification indicates slots that are selected for allocation, deallocation, duplicated allocation notification, reduce, or restart.

Referring to FIG. 4, the MLME-DSME-GTS.request primitive is generated the source upper layer 120, and is transferred to the source MLME 110 to request a slot management. When receiving MLME-DSME-GTS.request primitive from the upper layer 120, the source MLME 110 transmits the DSME-GTS request command to the destination MLME 220. Therefore, the MLME-DSME-GTS.request primitive includes a device address, and a management type, a number of slots, a preferred superframe, a preferred slot ID and a DSME SAB specification that are described in the DSME-GTS request command. The device address indicates an address of a neighboring node to request the management of the DSME-GTS, that is, an address of the destination node 200.

The MLME-DSME-GTS.indication primitive is generated by the destination MLME 210, and is transferred to the upper layer 220 upon the reception of the DSME-GTS request command. Therefore, the MLME-DSME-GTS.request primitive includes a device address, and a management type, a number of slots, a preferred superframe, a preferred slot ID and a DSME SAB specification that are described in the DSME-GTS request command. The device address indicates an address of a node that has transmitted the DSME-GTS request command, that is, an address of the source node 100.

The MLME-DSME-GTS.response primitive is generated by the destination upper layer 220, and is transferred to the destination MLME 210 to respond the management of the DSME-GTS. Therefore, the MLME-DSME-GTS.response primitive includes a device address, a management type, and a DSME SAB specification and a status that are described in the DSME-GTS reply command. The device address indicates an address of a node that has transmitted the received DSME-GTS request command, that is, the address of the source node 100.

When receiving the DSME-GTS reply command, the source MLME 110 checks whether the status indicates “success” when the destination address of the DSME-GTS reply command is the same as its own address. When the status indicates “success”, the source MLME 110 generates the DSME-GTS notify command and transmits it to the destination node 220. Further, the source MLME 110 generates the MLME-DSME-GTS.confirm primitive to notify the upper layer 120 of the result of the management request. Therefore, the MLME-DSME-GTS.confirm primitive includes a device address, and a management type, a DSME SAB specification and a status that are described in the MLME-DSME-GTS.response primitive. The device address indicates an address of a node that has transmitted DSME-GTS reply command, that is, the address of the destination node 100. When the destination address of the DSME-GTS reply command is different to its own address, the source MLME 110 updates its own DSME SAB based on the DSME SAB specification of the DSME-GTS reply command to reflect the DSME-GTS management result of the neighboring node.

When the destination address of the received DSME-GTS notify command is the same as its own address, the destination MLME 210 notifies the upper layer 220 of the receipt of the DSME-GTS notify command using the MLME-COMM-STATUS.indication primitive. When the device address of the DSME-GTS notify command is different to its own address, the destination MLME 210 updates its own DSME SAB based on the DSME SAB specification of the DSME-GTS notify command to reflect the DSME-GTS management result of the neighboring node.

Referring to FIG. 4 again, if the source MLME 110 does not receive the acknowledge message after transmitting the DSME-GTS request command to the destination node 200 (S420), the source MLME 110 transfers the MLME-DSME-GTS.confirm primitive with a status of NO_ACK (a receipt failure of the acknowledgement message) to the upper layer 120 (S480).

If the source node 100 receives no DSME-GTS reply command during a wait time after transmitting the DSME-GTS request command (S420), the source node 100 transfers the MLME-DSME-GTS.confirm primitive with a status of NO_DATA (a receipt failure of data) to the upper layer 120 (S480). The wait time may be represented as a maximum wait time (macMaxFrameTotalWaitTime) of a MAC layer.

As described above, according to an embodiment of the present, since the slots can be allocated by exchanging the three command frames and the primitive exchange between the MLME and the upper layer, the data delay can be minimized. Further, since the slot information of the neighboring node can be updated by the DSME-GTS reply command and the DSME-GTS notify command, the reliability of slot allocation can be improved.

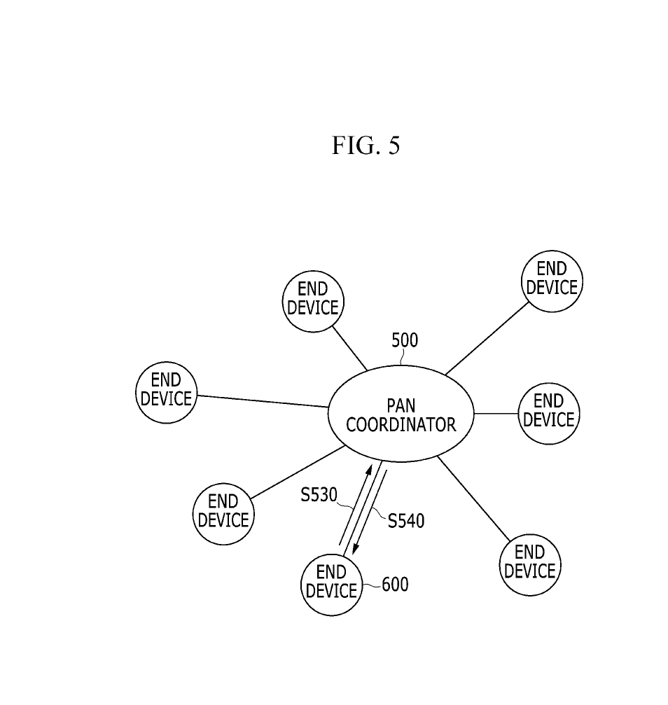

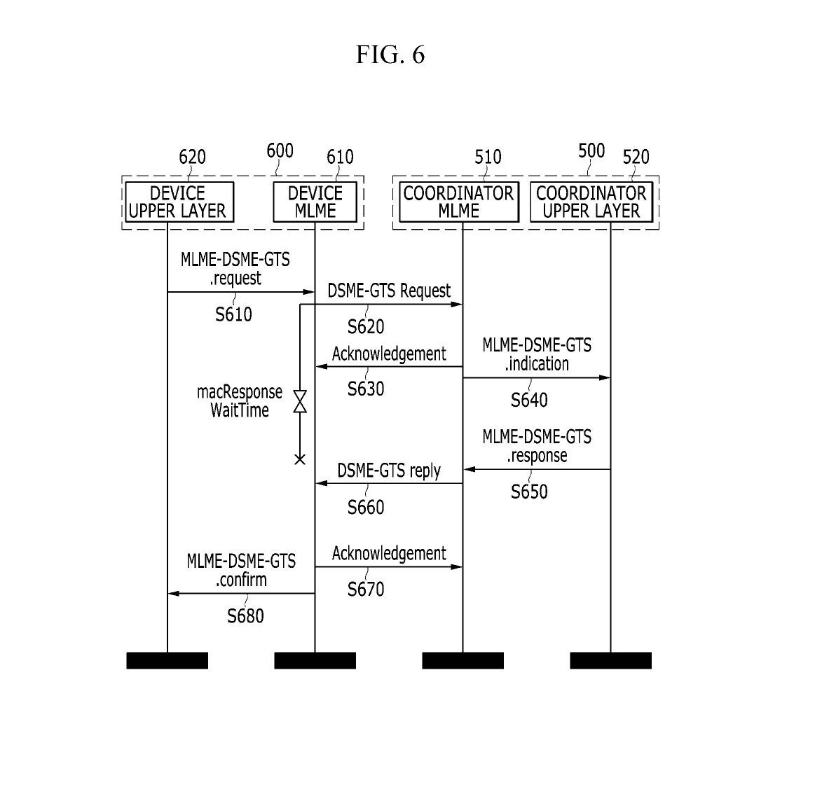

FIG. 5 is a schematic drawing showing a slot management method according to another embodiment of the present invention, and FIG. 6 is a signal flowchart of a slot management method according to another embodiment of the present invention.

As shown in FIG. 5, a wireless sensor network may be formed in a star topology. That is, a plurality of end devices 600 are connected to a PAN coordinator 500. The end device 600 is a node that can perform a data transmission function with an upper node but cannot perform a routing function. A slot management method described above may be expanded such that the PAN coordinator manages slot allocations of entire end devices. This embodiment is described with reference to FIG. 5 and FIG. 6.

Referring to FIG. 5, the end device 600 transmits a DSME-GTS request command to the PAN coordinator 500 to request slot allocation information (S530). The PAN coordinator 500 allocates slots to the end device 600, and then transmits a DSME-GTS reply command including slot allocation information to the end device 600 (S540). The slot allocation information may include a beacon interval (BI) index, a superframe identifier (ID), a slot ID, and a channel index to represent the slots allocated to the end device 600.

Parameters of the DSME-GTS request command and the DSME-GTS reply command described in FIG. 5 are described with reference to Table 5 and Table 6.

Referring to Table 5, a frame of the DSME-GTS request command includes a DSME-GTS management field and an allocation order (AO) field. The frame of the DSME-GTS request command may further include an MHR field and a command frame ID field as described in Table 1. The MHR field includes a destination address, and the destination address is set to an address of the PAN coordinator.

TABLE 5

| Octets | Names |
|---|---|
| Variable | MHR |
| 1 | Command Frame ID |
| 1 | DSME-GTS Management |
| 0/1 | Number of Slots |
| 0/2 | Preferred Superframe ID |
| 0/1 | Preferred slot ID |
| Variable | DSME SAB Specification |
| 0/1 | Allocation Order |

In Table 5, the allocation order field is not used in a scheme exchanging the three command frames described within reference to FIG. 3 and FIG. 4 (hereinafter referred to as a “3-way handshake scheme”), but is used in a scheme exchanging the two command frames described within reference to FIG. 6 (hereinafter referred to as a “2-way handshake scheme”). The 2-way handshake scheme is applied to an extended DSME mode. In a multi-superframe structure of the extended DSME mode, the MO is larger than the BO. That is, the multi-superframe duration is longer than the beacon interval. In this case, a plurality of beacon intervals (BIs) exist within a multi-superframe duration. The allocation order (AO) indicates its data transmission cycle at the maximum BI within the multi-superframe duration, i.e., a DSME-GTS allocation interval. The DSME-GTS allocation interval may be set by the allocation order (AO) as in Equation 2.

DSME-GTS allocation interval=BI×2^{(MO-BO)}/2^{AO} for MO>BO

The DSME-GTS management field may further include a management type field, a direction field, a prioritized channel access field, and a reserved field as in Table 3. The management type field may include information shown in Table 2.

The number of slots field, the preferred superframe ID field, the preferred slot ID field and the DSME SAB specification field are not used in Table 5 when the DSME-GTS allocation type field indicates the 2-way handshake scheme.

Referring to Table 5, a frame of the DSME-GTS reply command includes a DSME-GTS management field, an allocation order field, and a field representing information of allocated slots. As described in Table 4, the frame of the DSME-GTS reply command may further include an MHR field and a command frame ID field. The MHR field includes a destination address, and the destination address is set to an address of the end device which requests the slot allocation. The DSME-GTS management field includes information described above.

TABLE 6

| Octets | Names |
|---|---|
| Variable | MHR |
| 1 | Command Frame ID |
| 1 | DSME-GTS Management |
| 2 | Destination Address |
| 0/1 | Channel Offset |
| Variable | DSME SAB Specification |
| 0/1 | Allocation Order |
| 0/1 | BI Index |
| 0/2 | Superframe ID |
| 0/1 | Slot ID |
| 0/2 | Channel Index |

The allocation order field and the field representing the allocation information of slots are used in the 2-way handshake scheme, and the 2-way handshake scheme is applied to the extended DSME mode. The allocation order field indicates its data transmission cycle at the maximum BI within the multi-superframe duration, i.e., a DSME-GTS allocation interval. As described above, the DSME-GTS allocation interval may be set by the allocation order (AO) as in Equation 2.

The field representing the allocation information of slots includes the BI index field, the superframe ID field, and the slot ID field. The BI index field indicates a BI index. The BI index is one of values for identifying the allocated slots, and indicates the allocated beacon interval (BI) within the MD. The superframe ID field indicates a superframe ID for identifying the allocated superframe within the allocated beacon interval (BI). The slot ID field indicates a slot ID for identifying the allocated DSME-GTS within the allocated superframe. The field representing the allocation information of slots may further include a channel index field. The channel index field indicates a channel index for identifying channel information required in a channel adaptation mode.

The destination address field, the channel offset field, and the DSME SAB specification field are not used in Table 6 when the DSME-GTS allocation type field indicates the 2-way handshake scheme.

As described above, according to the present embodiment, the PAN coordinator 510 can manage slots of the plurality of end devices 520 by the handshake of the DSME-GTS request command and the DSME-GTS reply command, i.e., the 2-way handshake, and minimize the data delay.

While it has been exemplified in FIG. 5 that the slots are allocated by the DSME-GTS request command and the DSME-GTS reply command, other managements of slots can be performed by these commands as described with reference to FIG. 3 and FIG. 4.

Next, a primitive exchange between an MLME and an upper layer according to the commands shown in FIG. 5 is described with reference to FIG. 6.

Referring to FIG. 6, an upper layer 620 of an end device 600 transfers an MLME-DSME-GTS.request primitive that is a primitive for requesting a slot management to an MLME 610 of the end device 600 (S610). The MLME-DSME-GTS.request primitive includes a device address for indicating an address of the PAN coordinator 500, and a management type and an allocation order described in the DSME-GTS request command. The allocation order indicates the 2-way handshake scheme. The device MLME 610 generates the DSME-GTS request command and transmits the DSME-GTS request command to the PAN coordinator 500 (S620). An MLME 510 of the PAN coordinator 500 may transmit an acknowledgement message to the DSME-GTS request command to the device MLME 610 (S630).

Next, the coordinator MLME 510 transfers an MLME-DSME-GTS.indication primitive for reporting the receipt of the DSME-GTS request command to an upper layer 520 of the PAN coordinator 500 (S640). The MLME-DSME-GTS.indication primitive includes a device address for indicating an address of the end device 600 which has transmitted the DSME-GTS request command, and a management type and an allocation order described in the DSME-GTS request command. The coordinator upper layer 520 performs the management requested by the end device 600 in accordance with the MLME-DSME-GTS.indication primitive, and transfers an MLME-DSME-GTS.response primitive as a response to the coordinator MLME 510 (S650). The coordinator upper layer 520 performs the requested management in accordance with the DSME-GTS allocation interval indicated by the allocation order when the MO is larger than the BO. The requested management is allocation of new DSME-GTSs, or deallocation, duplicated allocation notification, reduce, or restart of existing DSME-GTSs. The MLME-DSME-GTS.response primitive includes a device address for indicating an address of the end device 600 which has transmitted the DSME-GTS request command, a management type, and an allocation order and information of slots described in the DSME-GTS reply command.

Then, the coordinator MLME 510 generates a DSME-GTS reply command and transmits the DSME-GTS reply command to the end device 600, to report the result of management request (S660). The device MLME 610 may transmit an acknowledgement message to the DSME-GTS reply command to the coordinator MLME 510 (S670).

Further, the device MLME 610 transfers an MLME-DSME-GTS.confirm primitive to the upper layer 620 to report the result of management request (S680). The MLME-DSME-GTS.confirm primitive includes a management type, an allocation order, and information of slots described in the MLME-DSME-GTS.response primitive.

If the end device 600 receives no DSME-GTS reply command during a predetermined wait time after receiving the acknowledgement message to the DSME-GTS request command (S630), the end device 600 transfers the MLME-DSME-GTS.confirm primitive with a status of NO_DATA (a receipt failure of data) to the upper layer 620 (S680). The wait time may be represented as a response wait time (macMaxFrameTotalWaitTime) of a MAC layer.

As described above, according to the present embodiment, since slots can be managed by the 2-way handshake of command frames and primitive exchanges between the MLME and the upper layer, control information and the data delay can be minimized. Further, the DSME-GTS allocation interval can be adjusted by the allocation order in a structure where the MO is larger than the BO.

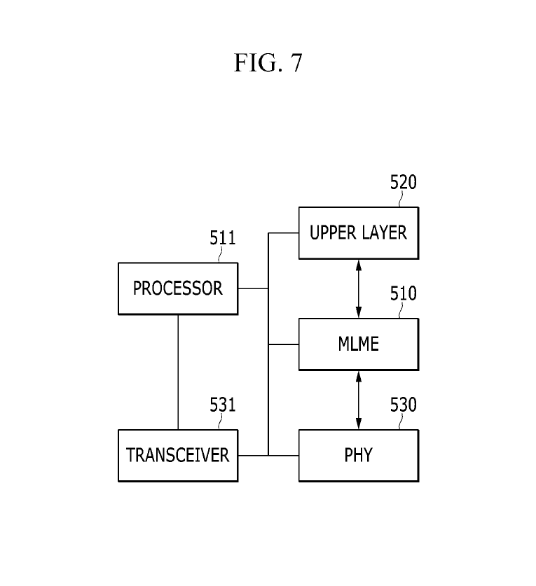

FIG. 7 is a block diagram of a slot management apparatus according to an embodiment of the present invention.

Referring to FIG. 7, an MLME 510 and an upper layer 520 of a PAN coordinator 500 described above may be implemented or executed by a hardware processor 511. A transceiver 531 that is formed on a physical layer (PHY) 530 of the PAN coordinator 500 may transmit a DSME-GTS reply command transferred from the MLME 510 to an end device 600, and may receive a DSME-GTS request command from the end device 600 and transfer the DSME-GTS request command to the MLME 510. Similarly, an MLME 610 and an upper layer 620 of the end device may be implemented or executed by a hardware processor included in the end device 600. Further, a transceiver that is formed on the PHY of the end device 600 may transmit the DSME-GTS request command transferred from the MLME 610 to the PAN coordinator 500, and may receive the DSME-GTS reply command from the PAN coordinator 500 and transfer the DSME-GTS reply command to the MLME 610.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of managing a slot by a coordinator to which a plurality of end devices are connected in a wireless network, the method comprising:
receiving a request command for requesting a slot management from a predetermined end device; and
transmitting a reply command including a result of the slot management request to the end device in accordance with the slot management request,
wherein each of the request command and the reply command includes an allocation order for indicating a slot allocation interval.

2. The method of claim 1, wherein the coordinator includes a first layer and a second layer that is an upper layer of the first layer, and
wherein the method further comprises:
transferring a first primitive for reporting a receipt of the request command from the first layer to the second layer the first; and
transferring a second primitive from the second layer to the first layer, as a response to the slot management request.

3. The method of claim 1, wherein a scheme for exchanging the request command and the reply command is applied to a mode in which a multi-superframe duration is longer than a beacon interval.

4. The method of claim 1, wherein the slot allocation interval is defined as BI×2^{(MO-BO)}/2^{AO}, and
wherein the BI indicates a beacon interval, the MO indicates a value for representing a multi-superframe duration, the BO indicates a value for representing the beacon interval, and the AO indicates the allocation order.

5. The method of claim 4, wherein the beacon interval is a product of a predetermined duration and 2^{BO}, and the multi-superframe duration is a product of the predetermined duration and 2^{MO}.

6. The method of claim 1, wherein the result of the slot management request includes an index of an allocated beacon interval, an identifier of an allocated superframe within the allocated beacon interval, and an identifier of an allocated slot within the allocated superframe.

7. The method of claim 6, wherein the result of the slot management request further includes a channel index indicating channel information.

8. A method of managing a slot by an end device connected to a coordinator in a wireless network, the method comprising:
transmitting a request command for requesting a slot management to the coordinator; and
receiving a reply command including a result of the slot management request from the coordinator,
wherein each of the request command and the reply command includes an allocation order for indicating a slot allocation interval.

9. The method of claim 8, wherein the end device includes a first layer and a second layer that is an upper layer of the first layer, and
wherein the method further comprises:
transferring a first primitive for requesting the slot management from the first layer to the second layer; and
transferring a second primitive for reporting the result of the slot management request from the second layer to the first layer.

10. The method of claim 8, wherein a scheme for exchanging the request command and the reply command is applied to a mode in which a multi-superframe duration is longer than a beacon interval.

11. The method of claim 8, wherein the slot allocation interval is defined as BI×2^{(MO-BO)}/2^{AO}, and
wherein the BI indicates a beacon interval, the MO indicates a value for representing a multi-superframe duration, the BO indicates a value for representing the beacon interval, and the AO indicates the allocation order.

12. The method of claim 11, wherein the beacon interval is a product of a predetermined duration and 2^{BO}, and the multi-superframe duration is a product of the predetermined duration and 2^{MO}.

13. The method of claim 8, wherein the result of the slot management request includes an index of an allocated beacon interval, an identifier of an allocated superframe within the allocated beacon interval, and an identifier of an allocated slot within the allocated superframe.

14. The method of claim 13, wherein the result of the slot management request further includes a channel index indicating channel information.

15. A slot management apparatus of a coordinator to which a plurality of end device are connected in a wireless network, the apparatus comprising:
a transceiver configured to receive a request command for requesting a slot management from a predetermined end device and transmit a reply command to the end device; and
a processor configured to perform the slot management in accordance with the slot management request and generate the reply command including a result of the slot management request,
wherein each of the request command and the reply command includes an allocation order for indicating a slot allocation interval.

16. The apparatus of claim 15, wherein a scheme for exchanging the request command and the reply command is applied to a mode in which a multi-superframe duration is longer than a beacon interval.

17. The apparatus of claim 15, wherein the result of the slot management request includes an index of an allocated beacon interval, an identifier of an allocated superframe within the allocated beacon interval, and an identifier of an allocated slot within the allocated superframe.

18. A slot management apparatus of an end device connected to a coordinator in a wireless network, the apparatus comprising:
a processor configured to generate a request command for requesting a slot management; and
a transceiver configured to transmit the request command to the coordinator and receive a reply command including a result of the slot management request from the coordinator,
wherein each of the request command and the reply command includes an allocation order for indicating a slot allocation interval.

19. The apparatus of claim 18, wherein a scheme for exchanging the request command and the reply command is applied to a mode in which a multi-superframe duration is longer than a beacon interval.

20. The apparatus of claim 18, wherein the result of the slot management request includes an index of an allocated beacon interval, an identifier of an allocated superframe within the allocated beacon interval, and an identifier of an allocated slot within the allocated superframe.
